(19) United States
(12) Patent Application Publication
(10) Pub. No.: US 2025/0348417 A1
(43) Pub. Date: Nov. 13, 2025

(54) MACHINE LEARNING-BASED PLATFORM FOR SCRIPT INTERRUPTION HANDLING

(71) Applicant: Bank of America Corporation, Charlotte, NC (US)

(72) Inventors: Vinod Maghnani, Gurugram (IN); Vinod Krishnan, Chennai (IN); Rahul Devane, Thane West (IN); Sheetanshu Verma, Faizabad (IN); Yerninti Anil Kumar, Chennai (IN); N Pavan Kumar, Chennai (IN)

(21) Appl. No.: 18/658,413

(22) Filed: May 8, 2024

(51) Int. Cl. G06F 11/36

(52) U.S. Cl. CPC G06F 11/3688; G06F 11/362

(57) ABSTRACT

Aspects related to machine learning-based script interruption handling are provided. A computing platform may train a machine learning model to identify, for a test script interruption, a corrective action to resolve the interruption. The platform may receive information and details corresponding to an interruption associated with a test automation script. The platform may identify, by executing a machine learning model, a cause of the interruption and a predicted corrective to resolve the interruption. The platform may cause, based on identifying the predicted corrective action, initiation of the corrective action. The platform may update, based on the corrective action, the machine learning model. The platform may also resume the test automation script from the point of interruption.

### BACKGROUND

In a distributed development and operations (DevOps) environment, continuous testing is an approach to software testing in which applications are tested at every stage of the software development cycle. Continuous testing differs from traditional testing in that it involves ongoing and automated testing practices. Traditional testing occurs as a separate phase after software development. Continuous testing ensure that tests are executed frequently. Continuous testing is fast, efficient, and effective. Continuous testing aids in providing a faster time to market while assuring quality.

Continuous testing may be achieved by employing test automation scripts. However, test automation scripts do not always run without errors and interruptions. A test automation script may be interrupted due to several reasons including but not limited to unhandled popup message boxes, unhandled exception messages, automation tool error messages, and/or abrupt execution stops by the tester. In conventional systems, once an interruption occurs, the test automation script is not able resume testing from the interruption point. Instead, the entire test automation script must be run again from the beginning. This leads to redundancy in re-executing the portion of code that may have already been successfully tested, delays in time to market, and may require manual intervention. Therefore, there is a need to develop a method or system that may automatically take corrective actions upon detection of test automation script interruptions and then resume testing from the point of interruption.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical problems associated with current methods of managing test automation script interruptions. In accordance with one or more arrangements of the disclosure, a script interruption handling platform may monitor a test automation script in real time to identify any interruptions with respect to the test automation script and may analyze the interruption to identify a corrective action and implement the corrective action to minimize time lost due to the interruption.

In some arrangements, the script interruption handling platform may include a machine learning model that may be trained on historical data including but not limited to information and details of previous interruptions. The machine learning model may be trained to identify different types of interruptions, identify causes of interruptions, identify predicted corrective actions, and execute said corrective actions based on input of information from a current interruption. The script interruption handling platform may store the gained intelligence from training the machine learning model in an intelligence database.

The script interruption handling platform may monitor the application under test and the testing script for any interruptions. These interruptions may take one of many forms including but are not limited to unhandled popup messages boxes, unhandled exception messages, middle tier exception errors, user interface errors, script errors, object property changes, run time errors, and abrupt execution stop by the tester.

Upon detection of an interruption, the script interruption handling platform may generate initial observation details of the interruption. For instance, details may include but are not limited to information such as date, time, interruption type, path, script name, and file name. In some examples, the data may be formatted for processing by the machine learning model. A machine learning engine executing the machine learning model may use these details among other data such as data from the intelligence database to output or determine whether the interruption is one that can be handled by the script interruption handling platform and without user input and/or analysis.

If the machine learning engine identifies that the interruption can be processed by the script interruption handling platform, it may apply gained intelligence from the intelligence database to identify and execute a corrective action. If the machine learning engine identifies that user intervention is required, then it may send a notification to a user device indicating user input and/or analysis is required.

After a corrective action is taken either through the machine learning engine or through user input and/or analysis, the script interruption handling platform may cause the test script for which the interruption was detected to resume testing at the point of interruption. For instance, the script interruption handling platform may identify, from the information associated with the interruption including but are not limited to script name, file name, and line number of the script from which it needs to resume execution, the point of interruption and may cause the test script to resume testing from the identified point of interruption. In some examples, this may include generating an instruction or command that may be transmitted or sent to the computing device executing the script and executed by the computing device to cause the computing device to resume the interrupted test.

The script interruption handling platform may include a resumption log that may include a repository storing refined outputs from the machine learning engine. The corrective action and the resulting output may be stored in the resumption log. Data to be stored in the resumption log may include but are not limited to run identification, execution cycle number, iteration number, script skep demographics, path, script name, line number of the script from which it needs to resume execution, script resumption demographics, corrective action(s) taken, and predicted corrective action(s). The script interruption handling platform may analyze the resumption log and may use the gained intelligence from the analysis of the resumption log to update and/or validate the machine learning model. The script interruption handling platform may then store the gained intelligence into an intelligence database.

In some examples, the script interruption handling platform may identify if two or more previous resumption attempts are unsuccessful. If two or more previous resumption attempts are unsuccessful, the script interruption handling platform may identify that the interruption requires user intervention and cannot be resumed until it is resolved.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for machine learning-based script interruption handling in accordance with one or more example arrangements;

FIGS. 2A-2E depict an illustrative event sequence for machine learning-based script interruption handling in accordance with one or more example arrangements;

FIGS. 3A-3B depict illustrative graphical user interfaces depicting a corrective action notification interface and a corrective action recommendation interface generated by a script interruption handling platform in accordance with one or more example arrangements; and

FIG. 4 depicts an illustrative method for machine learning-based script interruption handling in accordance with one or more example arrangements.

### DETAILED DESCRIPTION

In the following description of various illustrative arrangements, reference is made to the accompanying drawings, which form a part hereof, and in which is shown, by way of illustration, various arrangements in which aspects of the disclosure may be practiced. In some instances, other arrangements may be utilized, and structural and functional modifications may be made without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief description of the concepts described further herein, some aspects of the disclosure relate to a machine learning-based platform for script interruption handling. In some instances, entities such as an enterprise organization (e.g., a financial institution, and/or other institutions) may include a DevOps environment that may develop, test and deploy software applications used by the enterprise organization, employees thereof, and the like. Test automation scripts are designed to test specific actions associated with a software application being tested and to verify the expected outcomes may be executed (e.g., by one or more computing devices). In some examples, an interruption may occur during execution of a test automation script. In conventional systems, once the interruption is investigated or addressed, the test automation script must be re-executed from the beginning. As a result, the time and resources used in the failed test automation script are wasted.

Accordingly, in some instances, entities such as an enterprise organization and/or other organizations/institutions may employ a script interruption handling platform, as described herein. A script interruption handling platform may leverage artificial intelligence and/or machine learning technologies to identify, in real time or substantially in real time, any interruptions with respect to the test automation script and may take any corrective actions necessary to ensure continuous testing. The script interruption handling platform may include a machine learning model and train the machine learning model on historical data including but not limited to data of previous interruptions. The machine learning model may be trained to identify different types of interruptions, generate corrective actions, and execute said corrective actions based on input of information from a current interruption. The script interruption handling platform may store the gained intelligence from training the machine learning model in an intelligence database. The script interruption handling platform may use details from the interruptions to output or determine whether the interruption is one that can be handled by the script interruption handling platform and without user input and/or analysis. If the script interruption handling platform identifies that the interruption can be processed by the script interruption handling platform, it may apply gained intelligence (e.g., by executing the machine learning model) from the intelligence database to identify and execute a corrective action. If the script interruption handling platform identifies that user intervention is required, it may send a notification to a user computing device indicating manual input and/or analysis is required. After a corrective action is employed, the script interruption handling platform may cause the test script for which the interruption was detected to resume testing at the point of interruption. The script interruption handling platform may include a resumption log that may include a repository to store refined outputs from the machine learning model. The script interruption handling platform may analyze the resumption log and may use the gained intelligence from the resumption log to update and improve the machine learning model.

These and various other aspects will be discussed more fully herein.

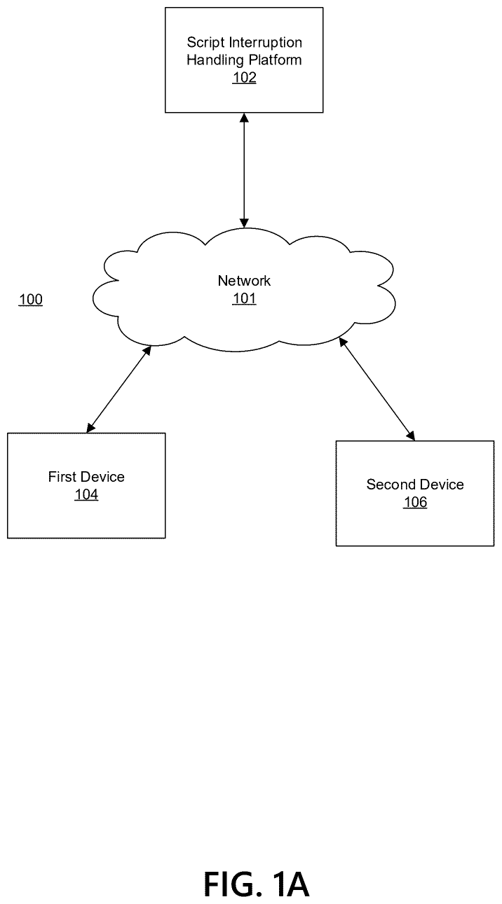

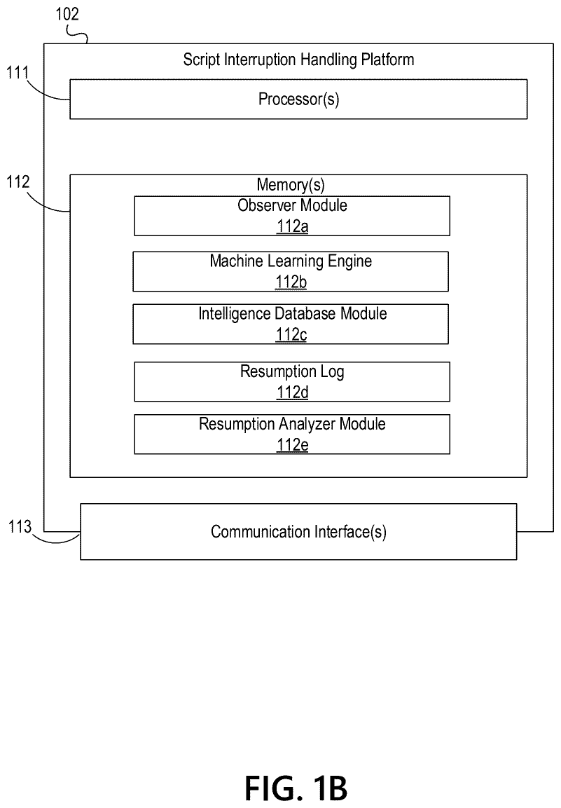

FIGS. 1A-1B depict an illustrative computing environment for machine learning-based script interruption handling in accordance with one or more example arrangements. Referring to FIG. 1A, computing environment 100 may include one or more computer systems. For example, computing environment 100 may include a script interruption handling platform 102, a first device 104, a second device 106, and/or other computing devices. Although one script interruption handling platform 102, one first device 104, and one second device 106 are shown, any number of devices or systems may be used without departing from the invention.

As described further below, script interruption handling platform 102 may be or include a computer system that includes one or more computing devices (e.g., servers, server blades, laptop computers, desktop computers, mobile devices, tablets, smartphones, and/or other devices) and/or other computer components (e.g., processors, memories, communication interfaces) that may be used to monitor test automation scripts associated with a network, enterprise, or the like, receive information and details of any interruptions to test automation scripts, identify cause(s) of interruptions, identify predicted corrective actions for interruptions, implement actual corrective actions for interruptions, and/or resume testing from the interruption point. The script interruption handling platform 102 may configure, train, and/or execute one or more machine learning models. For example, the script interruption handling platform 102 may train a machine learning model to identify interruptions to test automation scripts, identify predicted corrective actions, output actual corrective actions, and/or resume testing from the interruption point based on input of information and details of the interruption. The script interruption handling platform 102 may also train the machine learning model to identify whether the interruption is one of a type that the script interruption handling platform is able to analyze, process, and/or address. The script interruption handling platform 102 may be managed by and/or otherwise associated with an enterprise organization (e.g., a financial institution, and/or other institutions) that may, e.g., be associated with one or more additional systems (e.g., first device 104, second device 106, and/or other systems). In one or more instances, the script interruption handling platform 102 may be configured to communicate with one or more systems (e.g., first device 104, second device 106, and/or other systems) to identify interruptions to test automation scripts, identify predicted corrective actions, employ corrective actions, resume testing from the interruption point, and/or perform other functions.

The first device 104 may be a computing device (e.g., server, server blade, or the like) and/or other data storing or computing component (e.g., processors, memories, communication interfaces, databases) that may be used to perform testing functions (e.g., execute test automation scripts, display user interfaces, and/or other functions). The first device 104 may correspond to an entity (e.g., an enterprise organization, such as a financial institution and/or other institution). For example, the first device 104 may correspond to the same entity associated with the script interruption handling platform 102. In one or more instances, the first device 104 may be configured to communicate with one or more systems (e.g., script interruption handling platform 102, second device 106, and/or other systems) as part of receiving a transmission, sending a transmission, executing test automation scripts, and/or to perform other functions.

The second device 106 may be a computing device (e.g., server, server blade, or the like) and/or other data storing or computing component (e.g., processors, memories, communication interfaces, databases) that may be associated with an administrator or other user that may analyze test script interruptions that are not processed by the script interruption handling platform 110, receive and display notifications, and the like. The second device 106 may correspond to an entity (e.g., an enterprise organization, such as a financial institution and/or other institution). For example, the second device 106 may correspond to the same entity associated with the script interruption handling platform 102. In one or more instances, the second device 106 may be configured to communicate with one or more systems (e.g., script interruption handling transmission platform 102, first device 104, and/or other systems) as part of receiving a transmission, sending a transmission, displaying notices, and/or to perform other functions.

Computing environment 100 also may include one or more networks, which may interconnect script interruption handling platform 102, first device 104, and second device 106. For example, computing environment 100 may include a network 101 (which may interconnect, e.g., script interruption handling platform 102, first device 104, and second device 106).

In one or more arrangements, script interruption handling platform 102, first device 104, and second device 106 may be any type of computing device capable of monitoring test script execution to detect interruptions, analyzing interruptions to execute corrective actions, resuming testing from the point of interruption, and the like. For example, script interruption handling platform 102, first device 104, second device 106, and/or the other systems included in computing environment 100 may, in some instances, be and/or include server computers, desktop computers, laptop computers, tablet computers, or the like that may include one or more processors, memories, communication interfaces, storage devices, and/or other components. As noted above, and as illustrated in greater detail below, any and/or all of script interruption handling platform 102, first device 104, and second device 106 may, in some instances, be special-purpose computing devices configured to perform specific functions.

Referring to FIG. 1B, script interruption handling platform 102 may include one or more processors 111, memory 112, and communication interface 113. A data bus may interconnect processor 111, memory 112, and communication interface 113. Communication interface 113 may be a network interface configured to support communication between script interruption handling platform 102 and one or more networks (e.g., network 101, or the like). Communication interface 113 may be communicatively coupled to the processor 111. Memory 112 may include one or more program modules having instructions that, when executed by processor 111, cause script interruption handling platform 102 to perform one or more functions described herein, and/or one or more databases (e.g., an intelligence database 112c, or the like) that may store and/or otherwise maintain information which may be used by such program modules and/or processor 111. In some instances, the one or more program modules and/or databases may be stored by and/or maintained in different memory units of script interruption handling platform 102 and/or by different computing devices that may form and/or otherwise make up script interruption handling platform 102. For example, memory 112 may have, host, store, and/or include an observer module 112a, a machine learning engine 112b, an intelligence database 112c, a resumption log 112d, a resumption analyzer module 112e, and/or other modules and/or databases.

In some examples, one or more of the program modules and/or databases may be integrated together, overlap in one or more functions, and/or otherwise be associated with each other. Additionally, or alternatively, in some examples, the one or more program modules and/or databases may each comprise one or more additional modules and/or additional databases. It should be understood that the specific program modules described herein are merely examples and that one or more additional or alternative program modules may be hosted, stored, and/or otherwise included in memory 112 without departing from the scope of this disclosure.

Observer module 112a may have, store and/or include instructions that direct and/or cause script interruption handling platform 102 to communicate with the network 101, monitor test automation scripts executing on devices connected to network 101, receive information and details corresponding to interruptions to test automation scripts, generate initial observation details of interruptions, and/or perform other functions. For instance, initial observation details may include but are not limited to information such as date, time, interruption type, path, script name, and file name.

Machine learning engine 112b may have, store and/or include instructions that direct and/or cause script interruption handling platform 102 to train, execute, update and/or validate one or more machine learning models. For instance, the one or more machine learning models may be executed to identify an interruption type, identify whether the platform can handle the type of interruption, identify a predicted corrective action for the interruption, implement corrective actions, send transmissions to other devices on network 101, and/or perform other functions.

Intelligence database 112c may have, store and/or include instructions causing script interruption handling platform 102 to store gained intelligence from training the machine learning model, executing the machine learning model, implementing one or more corrective actions, and the like. In some examples, the intelligence database 112c may receive intelligence related to interruptions detected, corrective actions identified and/or executed, and the like, from interruptions addressed by the script interruption handling platform 102 and/or by a user or administrator providing analysis and/or input related to an interruption.

Resumption log 112d may have, store, and/or include instructions that direct and/or cause script interruption handling platform 102 to store refined outputs from the machine learning model. For instance, a corrective action associated with a detected interruption and the resulting output from the machine learning model may be stored in the resumption log. Data stored in the resumption log may include run identification, execution cycle number, iteration number, script skip demographics, path, script name, line number of the script from which it needs to resume execution, script resumption demographics, corrective action(s) taken, and predicted corrective action(s).

Resumption analyzer module 112e may have, store and/or include instructions that direct and/or cause script interruption handling platform 102 to analyze the resumption log 112d and may use the gained intelligence from the resumption log 112d and/or intelligence database 112c to update, validate and/or improve the machine learning model. Although observer module 112a, machine learning engine 112b, intelligence database 112c, resumption log 112d, and resumption analyzer module 112e are depicted as separate modules herein, the instructions stored by these modules may be stored in any number of modules without departing from the scope of this disclosure.

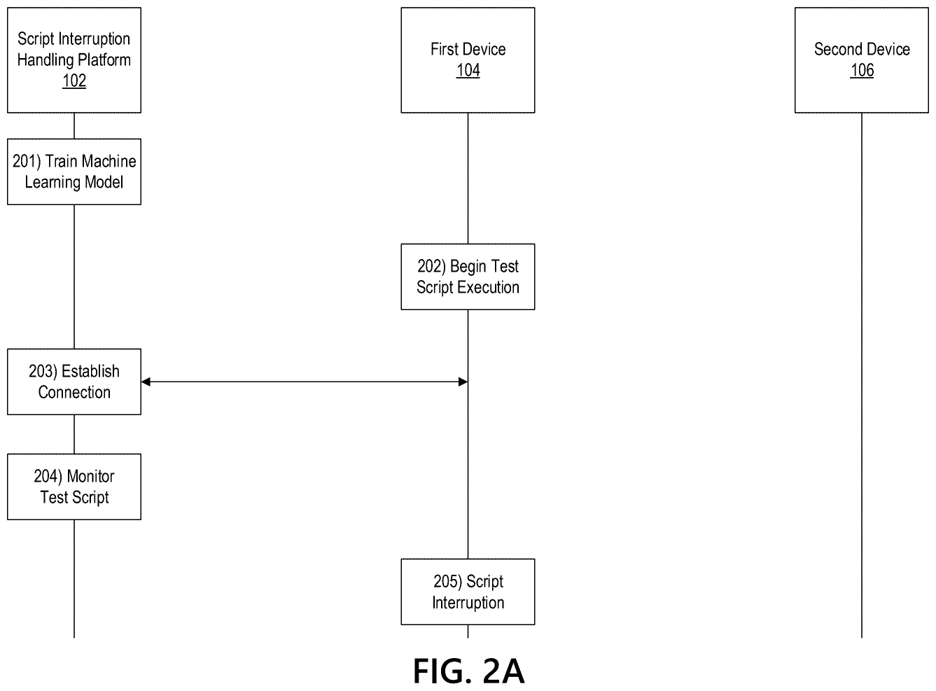

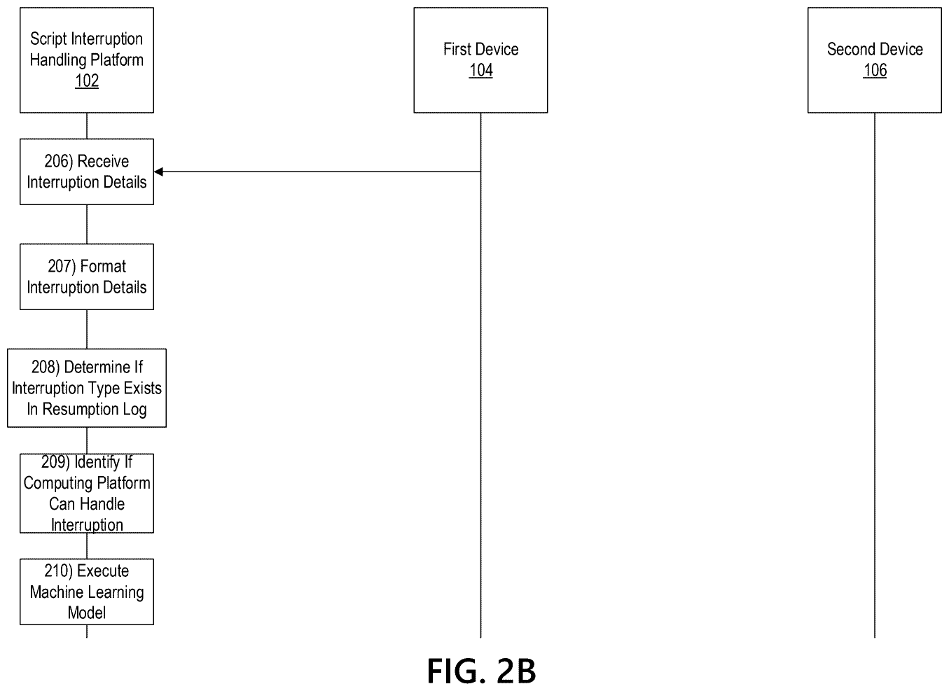

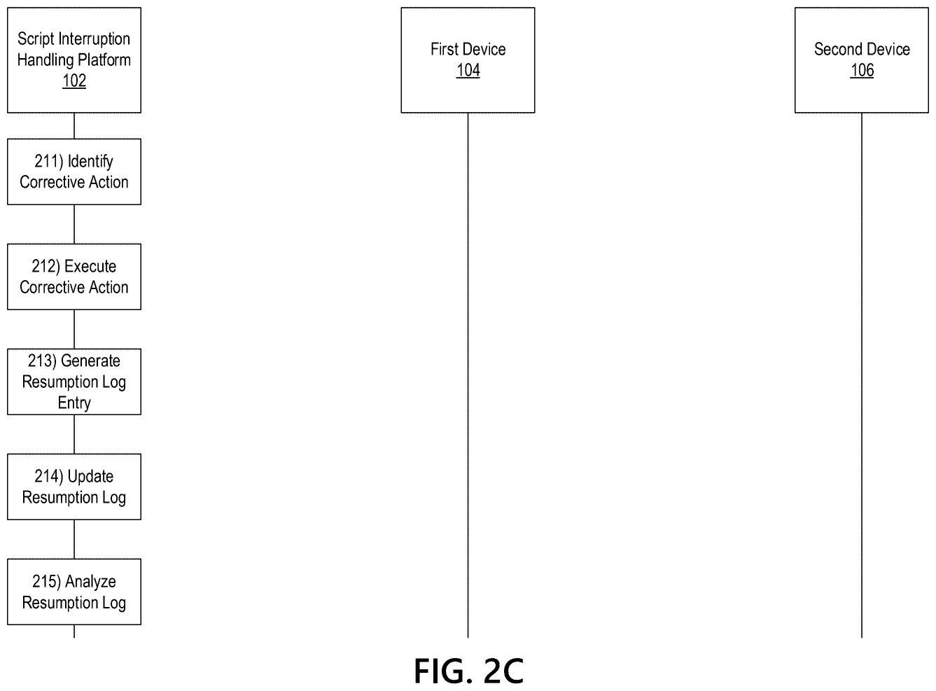

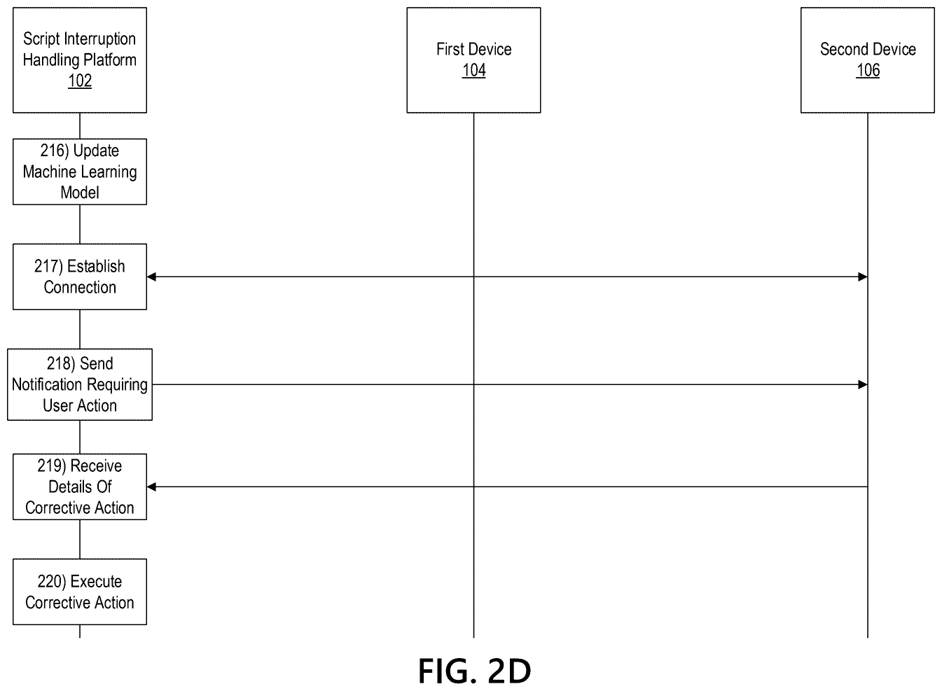

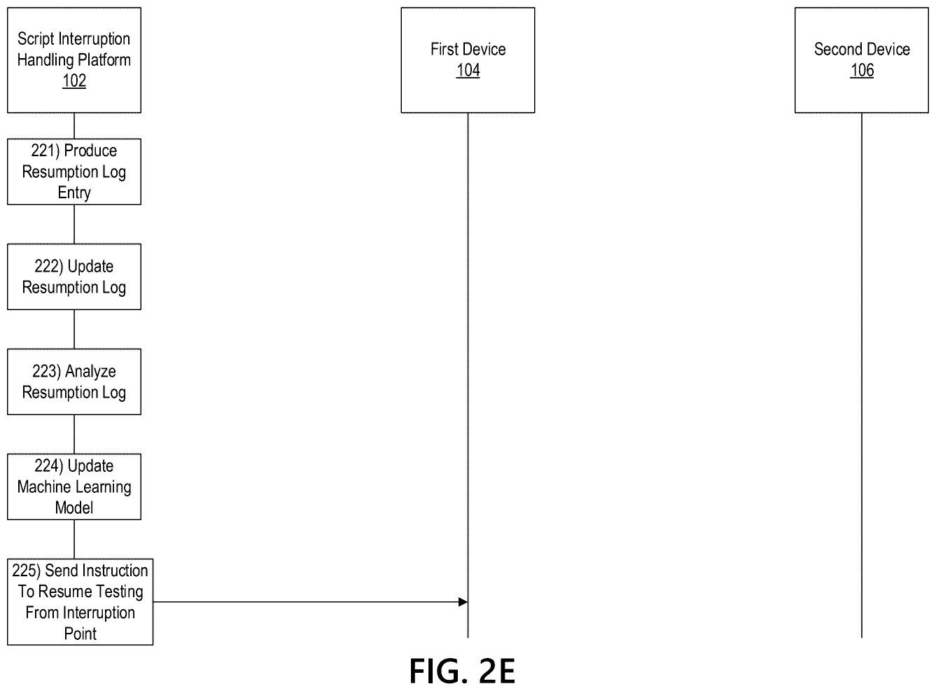

FIGS. 2A-2E depict an illustrative event sequence for machine learning-based script interruption handling in accordance with one or more example arrangements. Referring to FIG. 2A, at step 201, the script interruption handling platform 102 may train a machine learning model (e.g., executed by machine learning engine 112b). For example, the script interruption handling platform may use various techniques to train a machine learning model such as natural language processing, natural language understanding, supervised machine learning techniques (e.g., regression, classification, neural networks, support vector machines, random forest models, naïve Bayesian models, and/or other supervised techniques), unsupervised machine learning techniques (e.g., principal component analysis, hierarchical clustering, K-means clustering, and/or other unsupervised techniques), and/or other techniques. Training the machine learning model may configure the machine learning model to identify interruptions in execution of test automation scripts, identify whether the machine learning model is able to analyze and process the interruption (e.g., identify and address a cause, or the like), identify corrective action(s) to the root cause(s) of the interruption, generate resumption log entries, and/or update the machine learning model based on entries in the resumption log, corrective action identified and executed, and the like.

In some examples, the script interruption handling platform 102 may train the machine learning model based on historical interruption information. For example, the script interruption handling platform 102 may configure the machine learning model to identify issues associated with interruptions based on the historical interruption information. For instance, the script interruption handling platform 102 may configure the machine learning model to identify details of an interruption such as interruption type, path, script name, file name, line number of the script causing the interruption type, etc. In some arrangements, the model may be trained using labelled data identifying various parameters associated with a particular interruption and may identify patterns or sequences in the data that may aid in evaluating current interruption data.

In some examples, in configuring and/or otherwise training the machine learning model, the script interruption handling platform 102 may cause the machine learning model to generate and store, based on inputting the historical interruption information, one or more correlations between historical detected interruptions and the associated causes of the interruptions. In some examples, the script interruption handling platform 102 may cause the machine learning model to generate and store a correlation between historical interruptions and a security dialog, confirm dialog, error message, user stopping the script, database error, object property change, runtime error, and/or other issues related to an interruption to a test automation script. For instance, based on historical interruption information including metadata associated with an interruption indicating that data could not be found, the machine learning model may store a correlation indicating that the cause of the interruption is a database error. Additionally, or alternatively, in some examples, based on historical interruption information including metadata associated with an interruption indicating that warnings and/or confirmations are the cause of interruption, the machine learning model may store a correlation indicating that the cause of the interruption was due to an unhandled popup message box. Additionally, or alternatively, in some examples, based on historical interruption information including metadata associated with an interruption indicating that script errors, object property changes, and/or runtime errors are the cause of interruption, the machine learning model may store a correlation indicating that the cause of the interruption was due to automation tool error messages.

It should be understood that the above description of stored correlations merely recites examples of possible stored correlations, and that additional or alternative stored correlations may be generated and stored as part of configuring and/or otherwise training the machine learning model without departing from the scope of this disclosure. The script interruption handling platform 102 may cause the machine learning model to store the correlations in an intelligence database 112c accessible by and/or otherwise associated with the machine learning model.

In some examples, further based on the historical interruption information, the script interruption handling platform 102 may configure and/or train the machine learning model by storing additional correlations between identified causes of interruptions and implemented corrective actions. For example, based on storing a correlation indicating that a database error is the cause of the interruption and based on historical interruption data indicating that a successful corrective action was to reattempt connection and reinitiate the test automation script, the script interruption handling platform 102 may cause the machine learning model to store a correlation between database error and the corrective action of reattempt connection to the database. Additionally, or alternatively, based on storing a correlation indicating that an unhandled popup message box is the cause of an interruption and based on historical interruption information indicating that accepting the popup message box resolved the interruption, the machine learning model may store a correlation between unhandled popup message boxes and the corrective action of accepting the popup message box. It should be understood that these are merely examples of the additional correlations that might be stored by the machine learning model and that one or more additional or alternative correlations might be stored without departing from the scope of this disclosure. Based on storing the additional correlations, the machine learning model may be trained to identify, based on input of information of current interruptions (e.g., detected interruptions in an executing test script), the cause of the interruption and a predicted corrective action using the stored correlations.

In some examples, the stored correlations may be stored using a distributed ledger technology. A distributed ledger may be used to store a verified set of records securely and accurately using cryptography techniques. An advantage to using a distributed ledger may be that the information stored on a distributed ledger are replicated and shared across a network 101 of devices. As a result, the information stored on a distributed ledger may be less prone to cybercrime because all copies of the information need to be attacked simultaneously. The script interruption handling platform 102 may use various types of distributed ledger technologies including but not limited to: DAG, hashgraph, blockchain, and tangle. Tangle is a distributed ledger technology that is specifically designed for the internet of things (IoT) environment. Tangle may use a proof-of-work system to authenticate transactions on a distributed ledger. Tangle may use less energy and less time than traditional distributed ledger technologies.

At step 202, the first device 104 may execute a test automation script. Test automation scripts are designed to test specific actions of or associated with a software application and to verify the expected outcomes.

At step 203, the script interruption handling platform 102 may establish one or more connections with devices connected to a network, such as network 101 or the like. In establishing the one or more connections, the script interruption handling platform 102 may be deployed as an intermediate layer between devices that send and receive transmissions via the network 101. For example, the script interruption handling platform 102 may establish a connection with the first device 104. For example, the script interruption handling platform 102 may establish a first wireless data connection with the first device 104 to link the first device 104 with the script interruption handling platform 102 (e.g., in preparation for monitoring test automation scripts, receiving information corresponding to interruptions, and/or other functions). In some instances, the script interruption handling platform 102 may identify whether or not a connection is already established with the first device 104. If a connection is already established with the first device 104, the script interruption handling platform 102 might not re-establish the connection. If a connection is not yet established with the first device 104, the script interruption handling platform 102 may establish the first wireless data connection as described above. In some examples, the script interruption handling platform 102 may establish the connection automatically, as part of a monitoring process.

At step 204, based on establishing the one or more connections with devices (e.g., first device 104 and/or other devices), the script interruption handling platform 102 may monitor the executed test automation script for interruption to the test automation script, via shared connections established between the script interruption handling platform 102 and first device 104. In some examples, the script interruption handling platform 102 may monitor the first device 104 for interruption by executing one or more programs configured to monitor test automation scripts for interruption, by tracing, via shared connections, communications/transmissions sent from a source device (e.g., first device 104, and/or other devices) to a destination device (e.g., script interruption handling platform 102, and/or other devices) to identify interruptions, and/or by other methods.

At step 205, the first device 104 may encounter an interruption to the executed test automation script. The interruption may be one of various different types. For instance, the interruption may consist of an unhandled popup message box such as an info, warning, or confirmation notification. Additionally, or alternatively, the interruption may consist of an unhandled exception message such as an user interface warning, middle tier exception warning, or database error. Additionally, or alternatively, the interruption may consist of an automation tool error message such as a script error, object property change, or runtime error. Additionally, or alternatively, the interruption may consist of an abrupt execution stop by the user. It should be understood that these are merely examples of different types or interruptions to the test automation script and that other interruptions may occur without departing from the scope of this disclosure.

At step 206, based on the detected interruption of the test automation script at step 205 from the first device 104, the script interruption handling platform 102 may receive information or details of the detected interruption. For example, the script interruption handling platform 102 may receive or intercept from the first device 104 (e.g., the device executing the interrupted test script) information or details of the detected interruption via the communication interface 113 and while a wireless data connection is established. In some examples, the information or details of the interruption may include information corresponding to date of occurrence, time of occurrence, screenshot of interruption, interruption type, path, script name, file name, and/or any other information of and/or corresponding to the interruption.

At step 207, the script interruption handling platform 102 may format the interruption information received by the script interruption handling platform 102 at step 206. Formatting, by the script interruption handling platform 102, different types of interruptions may ensure that the script interruption handling platform 102 is capable of handling many different types of interruptions. The script interruption handling platform 102 may use various formatting tools. These tools may include image comparison, image matching, image processing, optical character recognition, and/or any other tools that may be used to read and format data.

Referring to FIG. 2B, at step 208, the script interruption handling platform 102 may determine whether an interruption type of the interruption exists in the resumption log 112d. If the script interruption handling platform 102 does not identify a matching interruption type, it may proceed to step 217 to begin the process of requesting user action. The resumption log 112d may store historical interruption information. The resumption log 112d may also store a correlation between historical failed interruptions and the causes of the interruptions. The resumption log 112d may also store a correlation between identified causes of interruptions and implemented corrective solutions. The resumption log 112d may also store details such as run identification number, execution cycle number, iteration number, path, script name, file name, and/or line number of the script from which it needs to resume execution. It should be understood that these are merely examples of the information and data that might be stored by the resumption log and that one or more additional or alternative types of data and information might be stored without departing from the scope of this disclosure. In some examples, the information stored in a resumption log 112d maybe stored using a distributed ledger technology including but not limited to DAG, hashgraph, block, and tangle.

At step 209, the script interruption handling platform 102 may identify, based on the information or details of the interruption, whether the interruption is a type that may be resolvable by the script interruption handling platform 102 (e.g., via the machine learning model). Identifying whether the interruption is resolvable by the machine learning model may be and/or comprise a first step in initiating a response to the interruption. In some instances, the script interruption handling platform 102 may use the machine learning model to compare the data and gained intelligence stored in the intelligence database 112c to the information of the interruption. Additionally, or alternatively, the script interruption handling platform 102 may compare the type of interruption to types of interruptions stored in the resumption log 112d. If, at step 209, the script interruption handling platform 102 identifies that the resumption log 112d does not include an interruption type matching the detected interruption, the script interruption handling platform 102 may identify that it is not capable of processing or resolving the interruption. In this case, the process may proceed to step 217 at FIG. 2D and begin the process to request intervention and/or analysis from a user. If the script interruption handling platform 102 identifies the resumption log 112d includes one or more interruptions corresponding to the interruption type of the detected interruption, the script interruption handling platform 102 may execute the machine learning model at step 210. Executing the machine learning model may include using correlations, such as correlations between information of the interruption and corrective actions and/or correlations between historical failed interruptions and the causes of the interruptions, to further determine or identify that the script interruption handling platform 102 can process the detected interruption.

Executing the machine learning model at step 210, may further include identifying, based on the information or details of the interruption, possible corrective action(s). In some examples, the machine learning model may compare the details of the interruption received from step 206 to the information stored in the intelligence database 112c. A similarity score may be produced. A similarity score may be a percentage of similarity between the details of the interruption and information stored in the intelligence database 112c. In one example, the score may range from 100% to 0%. A score of 100% may indicate that there is an exact match between the details of the interruption and the details stored in the intelligence database 112c. A score of 0% may indicate that there are no details of the interruption that match with information stored in the intelligence database 112c. A user may set a threshold score to indicate when the script interruption handling platform 102 may generate and execute a corrective action. In some examples, the machine learning model may compare a similarity score to a threshold to identify whether the most likely cause of an interruption corresponds to a historical cause of a historical interruption. For example, the machine learning model may compare the similarity score to a threshold score of 75%. If the quotient meets or exceeds 75%, the machine learning model may identify that the interruption corresponds to the historical interruption and, as a result, the cause of the interruption corresponds to the cause of the historical interruption. For example, if the quotient meets or exceeds 75%, the machine learning model may identify or determine that the interruption detected at the first device 104 corresponds to a historical interruption with a cause of an unhandled exception message and, as a result, the machine learning model may similarly identify that an unhandled exception message was the cause of the interruption from the first device 104. If the quotient meets or exceeds 50% but does not meet or exceed 75%, the machine learning model may continue executing machine learning model comparing the interruption to one or more additional historical interruptions. It should be understood that the above example is merely one algorithm the machine learning model may be trained to employ in order to generate the similarity score and/or identify the cause of the interruption, and in one or more instances additional or alternative algorithms may be employed and/or may correspond to different parameters. Additionally, it should be understood that in some instances multiple issues may have caused the interruption and, in these instances, the script interruption handling platform 102 may identify multiple causes based on the methods of identifying causes described above.

Referring to FIG. 2C, at step 211, based on identifying the cause of an interruption, the script interruption handling platform 102 may identify a predicted corrective action for the interruption. For example, the script interruption handling platform 102 may cause the machine learning model to identify, based on the previously input information of the interruption details and the determined cause of the interruption, a predicted corrective action for the interruption. In some examples, the script interruption handling platform 102 may cause the machine learning model to identify the predicted corrective action based on one or more stored correlations used to train and/or configure the machine learning model. The script interruption handling platform 102 may cause the machine learning model to identify or determine a predicted corrective action corresponding to the identified cause of the interruption. For example, if the identified cause of the interruption is an unconnected database, the machine learning model may identify, based on a stored correlation between unconnected database and the corrective action of reattempting connection, reattempting database connection as the predicted corrective action for the interruption. In some examples, the script interruption handling platform 102 may identify multiple predicted corrective actions based on identifying multiple causes of the interruption.

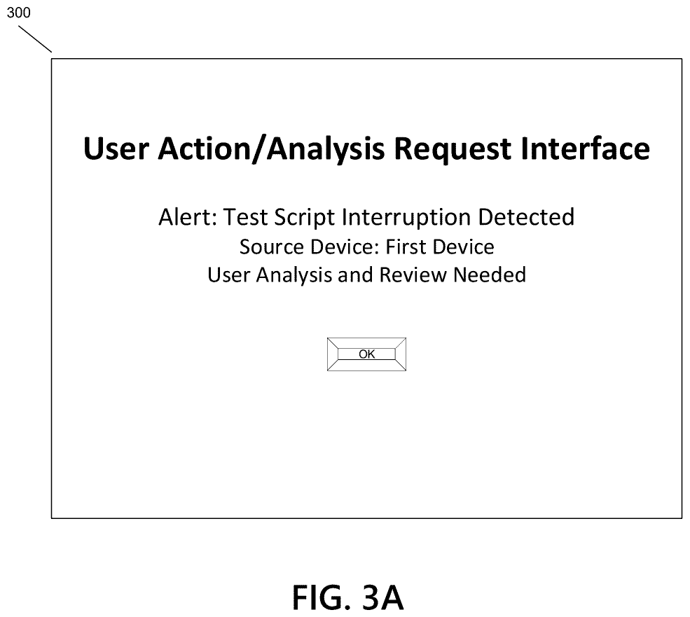

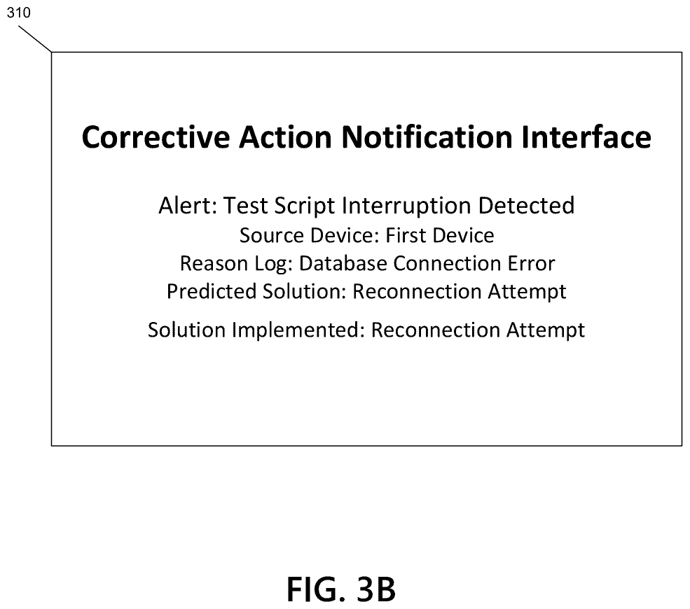

At step 212, based on identifying a predicted corrective action that is resolvable by the script interruption handling platform 102 and/or the machine learning model, the script interruption handling platform 102 may generate and/or implement the predicted corrective action to resolve the interruption. In some examples, the implemented corrective action may comprise generating, using the machine learning model, executable code configured to resolve one or more errors associated with the interruption. The machine learning model may generate the executable code based on one or more stored correlations associated with implemented corrective actions corresponding to one or more historical interruptions. For example, based on a stored correlation indicating that an interruption caused implementation of executable code configured to resend a transmission, locate a file corresponding to the interruption, re-establish a connection to a database corresponding to the script, and/or perform other functions, the script interruption handling platform 102 may cause the machine learning model to generate similar executable code configured to resolve one or more errors associated with the interruption from first device 104. Additionally, or alternatively, in some instances, the implemented corrective action may comprise generating and/or sending, to the first device 104 a recommendation of one or more actions configured to resolve one or more errors associated with the interruption. For example, based on identifying that the cause of the interruption was failed connection with a database, the script interruption handling platform 102 may generate and/or send a recommendation to the first device 104 recommending and/or instructing the first device 104 to attempt reconnection to the database corresponding to the interruption, and/or otherwise address the failed database connection. Additionally, the script interruption handling platform 102 may send a notification to a device (first device 104, second device 106, or the like) indicating that a corrective action has been taken. An exemplary corrective action notification interface 310 is illustrated in FIG. 3B. In some examples, the corrective action may be unsuccessful and the interruption is not resolved. In this case, in some arrangements, the corrective action may be reattempted. If two or more consecutive actions are unsuccessful, the script interruption handling platform 102 may send a notification to the second device 106 to request further user action. Additionally, or alternatively, in some instances, the received corrective action may comprise a recommendation of one or more actions configured to resolve one or more errors associated with the interruption. It should be understood that the above examples are merely illustrative and that one or more additional or alternative actual solution actions may be generated by the user without departing from the scope of this disclosure.

At step 213, based on identifying the cause of the interruption and executing a corrective action to resolve the interruption, the script interruption handling platform 102 may generate a resumption log entry for the interruption and corresponding corrective action. For example, the script interruption handling platform 102 may generate an entry comprising an indication of the identified cause of interruption, run identification number of the script, execution cycle number of the script, path name, script name, file name, line number of the script from which it needs to resume execution, and/or other information.

At step 214, based on generating a resumption log entry in step 213, the entry may be stored in the resumption log 112d. For example, the script interruption handling platform 102 may store the resumption log in memory 112 or, alternatively, in external memory. In some examples, the script interruption handling platform 102 may store the resumption log as a training record which may, for example, be used in training one or more additional machine learning model and/or additional iterations of the machine learning model. In some examples, the resumption log entry maybe stored using a distributed ledger technology including but not limited to DAG, hashgraph, block, and tangle.

At step 215, the script interruption handling platform 102 may analyze the resumption log 112d. In some examples, the script interruption handling platform 102 may use the machine learning model to analyze the resumption log 112d to find new correlations between interruptions, corrective actions, and/or other data. The machine learning model may employ various techniques to analyze the resumption log such as natural language processing, natural language understanding, supervised machine learning techniques (e.g., regression, classification, neural networks, support vector machines, random forest models, naïve Bayesian models, and/or other supervised techniques), unsupervised machine learning techniques (e.g., principal component analysis, hierarchical clustering, K-means clustering, and/or other unsupervised techniques), and/or other techniques.

Referring to FIG. 2D, at step 216, the script interruption handling platform 102 may update the machine learning model based on the gained intelligence from the analysis of the resumption log in step 214. In updating the machine learning model, the script interruption handling platform 102 may refine, validate, and/or otherwise update the machine learning model. For example, the script interruption handling platform 102 may update the machine learning model based on the predicted corrective action generated by the script interruption handling platform 102. In some instances, updating the machine learning model may comprise inputting the predicted corrective action into the machine learning model. By inputting the predicted corrective action into the machine learning model, the script interruption handling platform 102 may create an iterative feedback loop that may continuously and dynamically refine the machine learning model to improve its accuracy in identifying predicted corrective actions. For example, based on inputting the predicted corrective actions into the machine learning model, the script interruption handling platform 102 may cause the machine learning model to store and/or update one or more stored correlations for future iterations of the feedback loop. For example, based on the predicted corrective actions, the script interruption handling platform 102 may cause the machine learning model to store a correlation between the cause of the interruption and the predicted corrective action which may, for example, be used by the machine learning model as part of an algorithm, as part of a comparison, and/or otherwise used to identify predicted corrective actions to causes of interruptions in future iterations of the feedback loop.

At step 217, based on identifying that the interruption is not resolvable by the script interruption handling platform 102 or the machine learning model at step 209, the script interruption handling platform 102 may establish a connection to a second device 106. For example, the script interruption handling platform 102 may establish a second wireless data connection with the second device 106 to link the second device 106 with the script interruption handling platform 102 (e.g., in preparation for monitoring test automation scripts, receiving information corresponding to interruptions, and/or other functions). In some instances, the script interruption handling platform 102 may identify whether or not a connection is already established with the second device 106. If a connection is already established with the second device 106, the script interruption handling platform 102 might not re-establish the connection. If a connection is not yet established with the second device 106, the script interruption handling platform 102 may establish the second wireless data connection as described above. In some examples, the script interruption handling platform 102 may establish the connection automatically, as part of a monitoring process.

At step 218, based on identifying that the interruption is not resolvable by the script interruption handling platform 102 or the machine learning model 112b, the script interruption handling platform 102 may send a notification to the second device 106 notifying a user that user action and/or analysis is required. In some examples, sending the notification may additionally or alternatively comprise causing display of a user interface at one of more user devices. For example, the script interruption handling platform 102 may cause display of a user interface (e.g., a notification including a user analysis request interface, and/or other user interfaces) at the second device 106. For example, the script interruption handling platform 102 may cause display of the user interface via the communication interface 113 and while the second wireless data connection is established. The script interruption handling platform 102 may display a graphical user interface similar to the user action/analysis required notification 300, which is illustrated in FIG. 3A.

At step 219, the script interruption handling platform 102 may receive corrective action(s) from the second device 106. The corrective action(s) from the second device 106 may be generated from a user's actions and/or analysis input to the second device 106 to resolve the interruption. The user may examine any details produced by the script interruption handling platform 102 along with any other details that the user deems relevant. After the user has determined the corrective action to take, the user then sends the corrective action(s) to the script interruption handling platform 102 (e.g., via user input to second device 106). The script interruption handling platform 102 may receive the details of the user generated corrective action at step 219.

At step 220, the script interruption handling platform 102 may execute the corrective action received at step 219. Script interruption handling platform 102 may implement the received corrective action corresponding to the interruption. The corrective action may be executable code corresponding to resolving the interruption. For example, the script interruption handling platform 102 may send a notification to the second device 106 indicating that there is an issue with a lost connection to a database. The user may then determine that the corrective action to resolve the issue is to reattempt connection to the database. The user may then send details to the script interruption handling platform 102 including instructions to the platform to attempt reconnection to the database. In some examples, the corrective action may be unsuccessful and the interruption is not resolved. In this case, if two or more consecutive actions are unsuccessful, the script interruption handling platform 102 sends a notification to the second device 106 to request further user action. Additionally, or alternatively, in some instances, the received corrective action may comprise a recommendation of one or more actions configured to resolve one or more errors associated with the interruption. It should be understood that the above examples are merely illustrative and that one or more additional or alternative actual solution actions may be generated by the user without departing from the scope of this disclosure.

Referring to FIG. 2E, at step 221, the user may produce a resumption log entry similar to an entry produced in step 213 but corresponding to analysis and corrective actions identified by a user (e.g., via second device 106) and received by the script interruption handling platform 102. The resumption log entry may include details such as run identification number, execution cycle number, iteration number, path name, script name, file name, line number of the script from which it needs to resume action, predicted corrective action, actual corrective action and/or other details.

At step 222, based on generating the resumption log entry in step 221, the resumption log 112d may be updated by storing the entry in the resumption log 112d. For example, the script interruption handling platform 102 may store the resumption log in memory 112 or, alternatively, in external memory. In some examples, the script interruption handling platform 102 may store the resumption log as a training record which may, for example, be used in training one or more additional machine learning model and/or additional iterations of the machine learning model. In some examples, the resumption log entry maybe stored using a distributed ledger technology including but not limited to DAG, hashgraph, block, and tangle.

At step 223, the script interruption handling platform 102 may analyze the resumption log 112d. In some examples, the script interruption handling platform 102 may use the machine learning model to analyze the resumption log 112d to find or identify new correlations between interruptions, corrective actions, and/or other data. The machine learning model may employ various techniques to analyze the resumption log such as natural language processing, natural language understanding, supervised machine learning techniques (e.g., regression, classification, neural networks, support vector machines, random forest models, naïve Bayesian models, and/or other supervised techniques), unsupervised machine learning techniques (e.g., principal component analysis, hierarchical clustering, K-means clustering, and/or other unsupervised techniques), and/or other techniques.

At step 224, the script interruption handling platform 102 may update the machine learning model based on the gained intelligence from the analysis of the resumption log in step 223. In updating the machine learning model, the script interruption handling platform 102 may refine, validate, and/or otherwise update the machine learning model. For example, the script interruption handling platform 102 may update the machine learning model based on the corrective action received from the second device 106. In some instances, updating the machine learning model may comprise inputting the corrective action into the machine learning model. By inputting the corrective action into the machine learning model, the script interruption handling platform 102 may create an iterative feedback loop that may continuously and dynamically refine the machine learning model to improve its accuracy in identifying predicted corrective actions. For example, based on inputting the corrective actions into the machine learning model, the script interruption handling platform 102 may cause the machine learning model to store and/or update one or more stored correlations for future iterations of the feedback loop. For example, based on the corrective actions, the script interruption handling platform 102 may cause the machine learning model to store a correlation between the cause of the interruption and the corrective action which may, for example, be used by the machine learning model as part of an algorithm, as part of a comparison, and/or otherwise used to identify predicted corrective actions to causes of interruptions in future iterations of the feedback loop.

At step 225, after the execution of a corrective action to resolve the interruption, the script interruption handling platform 102 may send an instruction or command to the first device 104 causing the first device 104 to resume testing from the interruption point. The script interruption handling platform 102 may identify, from the information associated with the interruption such as script name, file name, and line number of the script from which it needs to resume execution, the point of interruption and may cause the test script to resume testing from the identified point of interruption. In some examples, this may include generating an instruction or command that may be transmitted or sent to the first device 104 and executed by the first device 104 to cause the first device 104 to resume the interrupted test.

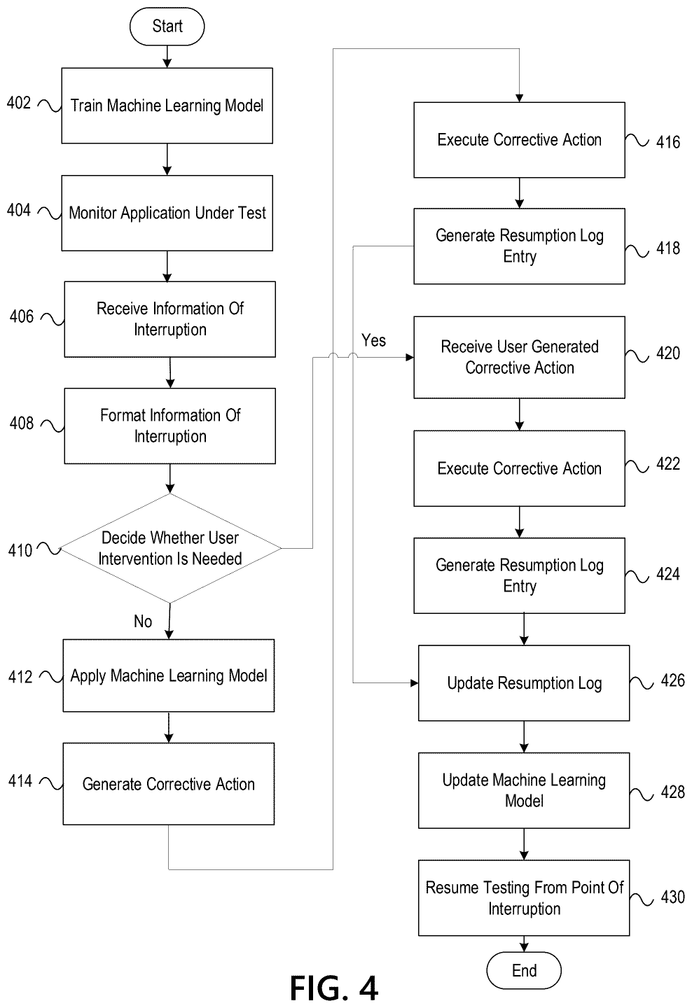

FIG. 4 depicts an illustrative method for machine learning-based script interruption handling in accordance with one or more example arrangements. Referring to FIG. 4, at step 402, a computing platform having at least one processor, a communication interface, and memory may train a machine learning model. For example, the computing platform may train a machine learning model to identify, based on details of a current test script interruption, a cause of the detected interruption and predicted corrective actions. At step 404, the computing platform may monitor one or more test scripts for interruption. For instance, the system may monitor a testing script for interruptions such as unhandled popup message boxes, unhandled exception messages, automation tool error messages, and/or abrupt execution stops by the tester. At step 406, the computing platform may detect an interruption and receive information and details regarding the interruption. At step 408, the computing platform may format the information and details received regarding the interruption for processing by the machine learning model. At step 410, the computing platform may execute the machine learning model to identify or determine whether the interruption is resolvable by the computing platform (e.g., using machine learning) or requires user action (e.g., administrator or other user input). If the computing platform identifies that the interruption is resolvable by the computing platform, the process may proceed to step 412. At step 412, the computing platform may execute the machine learning model using the interruption information as inputs to the model to identify a cause of the interruption. At step 414, the machine learning model may output, based on the identified cause and details of the interruption, one or more corrective action(s) (e.g., allocating more resources, reconnect to database, accepting error messages, reattempt testing) to resolve the interruption. At step 416, the computing platform may execute the corrective action. At step 418, the computing platform may generate a resumption log entry including details of the interruption, the implemented corrective action, and the like. The process may then proceed to step 426.

If, at step 410, the computing platform identifies that the interruption is not resolvable by the computing platform, the process may proceed to step 420. At step 420, the computing platform may send a notification to a user identifying the interruption and providing interruption details and may receive, from a computing device associated with the user one or more corrective actions generated by the user. At step 422, the computing platform may execute the received corrective action. At step 424, the computing platform may generate a resumption log entry based on the details of the interruption and the received user generated corrective action.

At step 426, the resumption log 112d may be updated with the newly generated resumption log entries from either step 418 or step 426. At step 428, the computing platform may execute the machine learning model to analyze the resumption log and then update the machine learning model based on the gained intelligence in the resumption log 112d. At step 430, the computing platform may resume the test automation script from the point of interruption. For instance, the computing platform may identify, from the information associated with the interruption including path name, script name, file name, line number of the script from which it needs to resume execution, and/or other information, the point of interruption and resume testing from that point.

One or more aspects of the disclosure may be embodied in computer-usable data or computer-executable instructions, such as in one or more program modules, executed by one or more computers or other platforms to perform the operations described herein. Generally, program modules include routines, programs, objects, components, data structures, and the like that perform particular operations or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various arrangements. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative arrangements, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative arrangements thereof. Numerous other arrangements, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
at least one of memory storing computer-readable instruction that, when executed by the at least one processor, configure the computing platform to:
train, based on historical data related to a plurality of test automation script interruptions, a machine learning model to identify, based on current test automation script interruption data, corrective actions for resolving interruptions to test automation scripts;
detect, based on monitoring at least one computing device executing a first test automation script, an interruption in the first test automation script;
identify data associated with the interruption, the data including at least identification of a point in the first test automation script at which the interruption occurred;
determine, based on the data associated with the interruption, whether the interruption can be processed by the computing platform;
responsive to determining that the interruption cannot be processed by the computing platform, transfer the data associated with the interruption to an administrator computing device for processing;
responsive to determining that the interruption can be processed by the computing platform:
execute the machine learning model, wherein executing the machine learning model includes inputting, to the machine learning model, the data associated with the interruption to output a corrective action for the interruption;
execute the corrective action;
after executing the corrective action, causing testing of the first test automation script to resume from the point in the first test automation script at which the interruption occurred;
record a plurality of information of the interruption and the executed corrective action in a resumption log; and
update the machine learning model based on the executed corrective action.

2. The computing platform of claim 1, wherein transferring the data associated with the interruption to an administrator computing device for processing further includes:
sending a correction notification to the administrator computing device, wherein sending the correction notification to the administrator computing device causes the administrator computing device to display the notification.

3. The computing platform of claim 1, wherein the computing platform stores additional computer-readable instructions that, when executed by the at least one processor, cause the computing platform to
format the information of the interruption; and
produce a formatted input entry based on the information of the interruption.

4. The computing platform of claim 1, wherein the computing platform stores additional computer-readable instructions that, when executed by the at least one processor, cause the computing platform to:
determine that the executed corrective action did not resolve the interruption;
responsive to determining that the executed corrective action did not resolve the interruption, execute the corrective action a second time; and
responsive to determining that executing the corrective action a second time did not resolve the interruption, send a correction notification requesting user input to the administrator computing device, wherein sending the notification causes the administrator computing device to display the correction notification.

5. The computing platform of claim 1, wherein the computing platform stores additional computer-readable instructions that, when executed by the at least one processor, cause the computing platform to:
identify, based on the information of the interruption, a type of the interruption.

6. The computing platform of claim 1, wherein the computing platform stores additional computer-readable instructions that, when executed by the at least one processor, cause the computing platform to:
identify, based on an analysis from the machine learning model, a cause of the interruption.

7. The computing platform of claim 1, wherein determining whether the interruption can be processed by the computing platform includes analyzing the resumption log to determine whether the resumption log includes interruptions having one of: a type or cause similar to a type or cause of the interruption.

8. The computing platform of claim 1, wherein the computing platform stores additional computer-readable instructions that, when executed by the at least one processor, cause the computing platform to:
capture details of a resumption such as run identification, execution cycle number, iteration number, script skip demographics, and script resumption demographics and records the details in the resumption log.

9. The computing platform of claim 1, wherein the computing platform stores additional computer-readable instructions that, when executed by the at least one processor, cause the computing platform to:
store data in a distributed ledger.

10. The computing platform of claim 1, wherein the computing platform stores additional computer-readable instructions that, when executed by the at least one processor, cause the computing platform to:
generate a similarity score based on a degree of similarity between the interruption and historical interruptions stored in the resumption log.

11. The computing platform of claim 1, wherein the computing platform stores additional computer-readable instructions that, when executed by the at least one processor, cause the computing platform to:
analyze the resumption log; and
store a first gained intelligence, based on the analysis of the resumption log, into an intelligence database.

12. A method comprising:
at a computing platform comprising least one processor, a communication interface, and memory:
training, based on historical data related to at least one of test automation script interruptions, a machine learning model to identify, based on current test automation script interruption data, corrective actions for resolving interruptions to test automation scripts;
detecting, based on monitoring at least one computing device executing a first test automation script, an interruption in the first automation script;
identifying data associated with the interruption, the data including at least identification of a point in the test automation script at which the interruption occurred;
determining, based on the data associated with the interruption, whether the interruption can be processed by the computing platform;
responsive to determining that the interruption cannot be processed by the computing platform, transferring the data associated with the interruption to an administrator computing device for processing;
responsive to determining that the interruption can be processed by the computing platform:
executing the machine learning model, wherein executing the machine learning model includes inputting, to the machine learning model, the data associated to output a corrective action for the interruption;
executing the corrective action;
after executing the corrective action, causing testing of the first test automation script to resume the test automation script from the point in the test automation script at which the interruption occurred;
recording a plurality of information of the interruption and the executed corrective action in a resumption log; and
updating the machine learning model based on the executed corrective action.

13. The method of claim 12, further comprising:
sending a correction notification to the administrator computing device, wherein sending the correction notification to the administrator computing device cases the administrator computing device to display the notification.

14. The method of claim 12, further comprising:
formatting the information of the interruption; and
producing a formatted input entry based on the information of the interruption.

15. The method of claim 12, further comprising:
sending a correction notification, after 2 or more consecutive resumption attempts are unsuccessful, directing the administrator computing device to display the correction notification wherein the correction notification requires user action.

16. The method of claim 12, further comprising:
identifying, based on the information of the interruption, a type of the interruption.

17. The method of claim 12, further comprising:
identifying, based on an analysis from the machine learning mode, a cause of the interruption.

18. The method of claim 12, further comprising:
analyze the resumption log to determine whether the resumption log includes interruptions having one of: a type or cause similar to a type or cause of the interruption.

19. The method of claim 12, further comprising:
capturing details of a resumption such as run identification, execution cycle number, iteration number, script skip demographics, and script resumption demographics and records the details in the resumption log.

20. One or more non-transitory computer-readable media storing instructions that, when executed by a computing platform comprising at least one processor, a communication interface, and memory, cause the computing platform to:
train, based on historical data related to a plurality of test automation script interruptions, a machine learning model to identify, based on current test automation script interruption data, corrective actions for resolving interruptions to test automation scripts;
detect, based on monitoring at least one computing device executing a first test automation script, an interruption in the first test automation script;
identify data associated with the interruption, the data including at least identification of a point in the first test automation script at which the interruption occurred;
determine, based on the data associated with the interruption, whether the interruption can be processed by the computing platform;
responsive to determining that the interruption cannot be processed by the computing platform, transfer the data associated with the interruption to an administrator computing device for processing;
responsive to determining that the interruption can be processed by the computing platform:
execute the machine learning model, wherein executing the machine learning model includes inputting, to the machine learning model, the data associated with the interruption to output a corrective action for the interruption;
execute the corrective action;
after executing the corrective action, causing testing of the first test automation script to resume from the point in the first test automation script at which the interruption occurred;
record a plurality of information of the interruption and the executed corrective action in a resumption log; and
update the machine learning model based on the executed corrective action.
